(19) United States
(12) Patent Application Publication
(10) Pub. No.: US 2003/0235474 A1
(43) Pub. Date: Dec. 25, 2003

(54) Multi-point conveyor system

(76) Inventors: David Carder, Highland Village, TX (US); Jack Balko, (US)

Correspondence Address: Kenneth T. Emanuelson, GARDERE WYNNE SEWELL LLP, Thanksgiving Tower, Suite 3000, 1601 Elm Street, Dallas, TX, 75201-4767, US

(21) Appl. No.: 10/178,942

(22) Filed: Jun. 24, 2002

(51) Int. Cl. B65G 53/40

(52) U.S. Cl. 406/117

(57) ABSTRACT

The present invention provides a method, apparatus and system for efficient conveyance of documents and small payloads between multiple departments of a business facility. Although not limited to application to financial institutions, the teachings of the present invention are particularly applicable to banking facilities. The system of the present invention centralizes the operations of transaction agents in a single location. Within the central location, one or more of the transaction agents has direct access to two or more remote locations via the use of two or more conveyors. Direct access to multiple locations allows the transaction agents to operate with much higher efficiency than that available through prior systems.

### FIELD OF THE INVENTION

The present invention relates generally to conveyor systems and more specifically to a system and apparatus for increasing the efficiency and security of logistical operations requiring the movement of papers and similar payloads.

### BACKGROUND OF THE INVENTION

Efficient and secure distribution of documents is a major concern to document handling and processing facilities such as banks and post offices. Methods to reduce the level of effort and risk of loss inherent in high-volume document handling operations have been devised, but most such methods leave room for improvement.

With increasing levels of competition within service industries, including the financial services industry, the marketing of services is becoming much more customer-oriented. For example, in the banking industry, there is a trend towards “open plan” branches, personal counseling and customer interaction across a desk rather than at a counter. In general, there is a trend ceding as much space as possible to the customer in lobby areas of the facilities. This trend tends to exacerbate the logistical and security problems inherent in the management of a financial institution.

The placement of service representatives at individual desks rather than along a single counter poses certain logistical problems. Service representatives or transaction agents working along a counter can be provided with ready access to documents and cash behind the desk while at the same time maintaining a relatively high level of security. In order to supplement security, service representatives operating at individual desks often work with secure enclosures located in close proximity to the desk. One example of such a unit contains a stock of cash in a locked housing and provides for the withdrawal of cash in required amounts in response to a request entered by the service representative. In the banking industry, these units are known as teller assist units or automatic teller safes. These teller assist units are similar in operation to automatic teller machines. Unfortunately, as these are stand-alone units distributed throughout the facility, documents, stocks of cash or other resources held in these units cannot be efficiently recirculated during business hours.

In the interest of increasing the efficient movement of documents and small payloads throughout a facility, pneumatic tube conveyor systems have been known for many years as a means of transporting a wide range of items (documents, valuables, samples, spare parts etc.) between different locations within a building, or even between adjoining buildings. The efficiency of the conveying mechanisms has, over time, been improved through various methods and apparatuses.

With suitable electronic controls, pneumatic conveyor systems are ideal for increasing the security and efficiency of transactions. Air tube conveyor systems are capable of operating over relatively long distances and in virtually any building, whether new or existing. Pneumatic tubes can be concealed above ceilings or below floors depending on the constraints of the building.

Certain prior customer interface facilities centralize agents along a single counter. This type of layout is common, for example, in bank lobbies and movie theater ticket counters. In banking facilities, these teller counters are sometimes equipped with pneumatic conveyors in communication with the drive-thru bays. Generally, these pneumatic conveyors are disposed in relatively close proximity to the counters, so that tellers working at the counters can be relatively easily re-deployed to service at the drive-thru conveyors.

The traditional bank lobby arrangement allows for efficiency improvements over more traditional designs having a first set of dedicated tellers for the teller counters and a second set of dedicated tellers for the drive-thru bays. Although this arrangement provides for a certain additional level of flexibility over an arrangement having a first set of dedicated drive-thru tellers and a second set of dedicated walk-up tellers, there are much greater efficiency gains to be realized.

A traditional pneumatic conveyor network, such as that used to convey documents to and from a drive-thru bay, is generally a single point-to-point apparatus. A certain inherent efficiency of the pneumatic conveyor increases the efficiency of the process as a whole, but the drive-thru conveyor does not take full advantage of the potential synergy between the conveyor apparatus and efficiency improvements available through the use of other labor-saving devices.

Although pneumatic tube conveyors have been employed effectively in many applications, there remain areas for improvement. Banking facilities, for example, have traditionally used pneumatic conveyors having a single access for transportation of documents, but such conveyors incorporate inherent drawbacks hindering their efficiency. One inherent drawback relates to the number of tellers able to access a particular conveyor conveniently and efficiently. It is intuitive that a single-access terminal of any particular conveyor can be readily accessed from at most two teller workstations. Although the terminal can be placed centrally between the teller workstations to provide optimal access to tellers at both workstations, there remains no point of ready access from a third or fourth teller workstation. Furthermore, although one single-access terminal can be reasonably and ergonomically accessed by two adjacent teller workstations, two or more single-access terminals disposed in this manner present considerable ergonomic and efficiency problems.

### SUMMARY OF THE INVENTION

In contrast to traditional communications conveyor systems, which make use of single-access conveyor terminals, the present invention makes use of multiple-access conveyor terminals, allowing more than two tellers to readily access a single conveyor terminal, or two or more tellers to share common access to a number of conveyor terminals. In certain embodiments, the shared terminals may include a combination of upsend and downsend conveyors, some vertically aligned and parallel so as to share ergonomic space.

The present invention provides for the employment of improved methods for efficiently distributing documents through a facility and efficiently performing transactions related to those documents. The present invention allows for substantial efficiency improvements over prior systems. An example of the type of institution able to make use of the present invention is a banking facility, but there is nothing within the spirit and scope of the present invention limiting it to any particular market or area of endeavor. The teachings of the present invention are useful in any business or facility in which a significant volume of transactions must be handled with limited resources.

The distribution system of the present invention is designed to maximize the efficiency of employees working with documents and other small payloads. The distribution system of the present invention additionally provides for a significant improvement in the flexibility of such employees.

In contrast to prior designs, the method and apparatus of the present invention provides for dramatic improvements in efficiency over traditional logistical systems, including those making a limited use of pneumatic conveyors. The teachings of the present invention are well-suited to use with pneumatic conveyors, but are by no means limited to such. The logistical aspects of the present invention are suitable for use with any form of conveyor capable of delivering a payload from one point to another reliably and in a relatively short time frame.

In a first embodiment, the present invention is a system for efficiently conducting transactions. The system includes a first agent work station and a second agent work station. A first conveyor terminal is disposed within ergonomic reach of both the first and second agent work stations, operably connected to a first conveyor for delivery to a first destination. A second conveyor terminal is disposed within ergonomic reach of both the first and second agent work stations, operably connected to a second conveyor for delivery to a second destination. Depending on the application, either of the destinations may be a drive-thru bay, a customer service desk, or a lobby terminal.

In a second embodiment, the present invention includes first, second, and third agent work stations. A first conveyor terminal is disposed within ergonomic reach of both the first and second agent work stations and operably connected to a first conveyor for delivery to a first destination. A second conveyor terminal is disposed within ergonomic reach of both the second and third agent work stations and operably connected to a second pneumatic conveyor for delivery to a second destination.

In a third embodiment, the present invention includes first, second, third, and fourth agent work stations. A first conveyor terminal is disposed within ergonomic reach of both the first and second agent work stations. The first terminal incorporates a first upward-acting conveyor operably connected to a first destination and a first downward-acting conveyor operably connected to a second destination. A second conveyor terminal is disposed within ergonomic reach of both the second and third agent work stations. The second terminal incorporates an upward-acting conveyor operably connected to a third destination and a downward-acting conveyor operably connected to a fourth destination. A third conveyor terminal is disposed within ergonomic reach of both the third and fourth agent work stations. The third terminal has an upward-acting conveyor operably connected to a fifth destination and a downward-acting conveyor operably connected to a sixth destination.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is an isometric view of an array of transaction agent stations in accordance with one embodiment of the present invention;

FIG. 2 is an isometric view of an array of transaction agent stations in accordance with a second embodiment of the present invention;

FIG. 3 is a top view of a four-place transaction agent cell in accordance with one embodiment of the present invention;

FIG. 4 is a top view of a four-place transaction agent cell in accordance with a second embodiment of the present invention;

FIG. 5 is a top view of an array of four-place transaction agent cells in accordance with one embodiment of the present invention;

FIG. 6 is a side view of the base portion of a transaction agent cell in accordance with one embodiment of the present invention;

FIG. 7 is a side view of a four-place transaction agent cell in accordance with one embodiment of the present invention;

FIG. 8 is an isometric view of a conveyor system in accordance with one embodiment of the present invention;

FIG. 9 is a plan view of a two-place transaction agent cell in accordance with one embodiment of the present invention;

FIG. 10 is a front elevation view of the two-place transaction agent cell of FIG. 9; and

FIG. 11 is a side elevation view of the two-place transaction agent cell of FIG. 9.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention and do not delimit the scope of the invention.

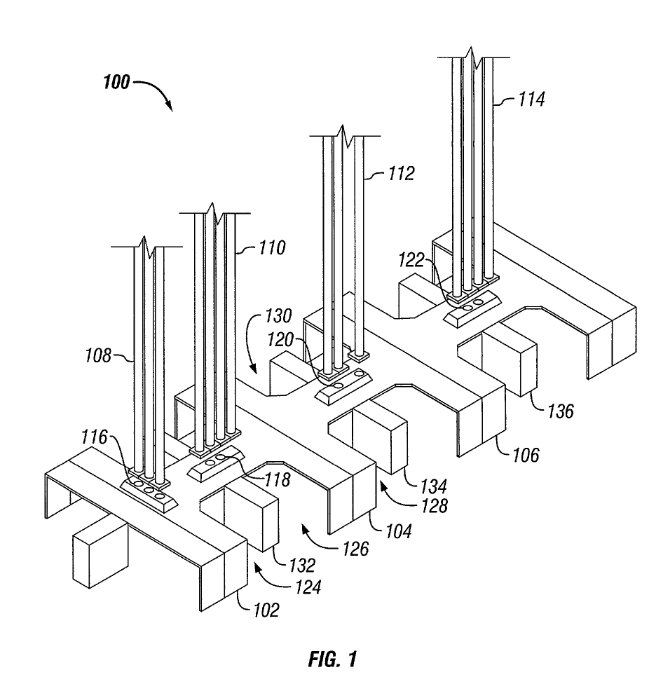

FIG. 1 is an isometric view of an agent center 100 of transaction agent stations in accordance with one embodiment of the present invention. The agent center 100 represents one embodiment of a layout that can be effectively employed in the overall system of the present invention in order to increase efficiency. As seen in FIG. 1, agent center 100 of transaction agent stations incorporates a group of three cells 102, 104, and 106. In the embodiment shown in FIG. 1, each of cells 102-106 incorporates four transaction agent stations, so that agent center 100 can potentially accommodate up to twelve transaction agents at one time.

Materials can be rapidly and efficiently moved to and from agent center 100 by means of a series of tubular conveyors arranged generally along the center of agent center 100 between the transaction agents. Upsend tubular conveyors 108 are arranged at one end of agent center 100, while upsend tubular conveyors 110, 112, and 114 are arranged down the center of the agent center 100. In the embodiment shown in FIG. 1, upsend tubular conveyors 108-114 employ an open arrangement allowing agents to access delivered contents from either side of the conveyors.

In addition to upsend conveyors 108-114, agent center 100 employs a set of downsend conveyors. Downsend tubular conveyors 116 are arranged at one end of agent center 100, while downsend tubular conveyors 118, 120, and 122 are arranged down the center of the agent center 100. In a similar manner to that described in connection with upsend conveyors 108-114, downsend tubular conveyors 116-122 employ an open arrangement allowing agents to access delivered contents from either side of the conveyors.

Each of the tubular conveyors 108-122 connects agent center 100 to one or more destinations remote from agent center 100. Downsend tubular conveyors 116, for example, may be connected to deliver materials to and from a set of drive-thru bays in a bank branch. At the same time, upsend conveyors 108 may be connected to deliver materials to and from agents working at customer service desks. The remainder of tubular conveyors 108-122 will be connected to other remote locations as requirements dictate. In certain embodiments, one or more of tubular conveyors 108-122 may be connected to another agent center.

In certain embodiments, each bank of tubular conveyors may be connected to a set of similar destinations. Connection of each of tubular conveyors 108 to a single bank drive-thru bay is such an example. In other embodiments, each bank of tubular conveyors may include one conveyor going each of a number of destinations. So, for example, the bank of conveyors numbered 110 may include one conveyor connected to a drive-thru bay, one conveyor connected to a customer service desk, one conveyor connected to a lobby teller machine, and one conveyor connected to another agent center. Other variations will be apparent to those of skill in the art.

Agents work in conjunction with the agent center 100 from within work stations such as 124, 126, 128, and 130. From each work station, an agent has access to a certain subset of the tubular conveyors 108-122. For example, an agent working from work station 124 will have ready access to conveyors 108, 110, 116, and 118. Depending on the manner of connection scheme employed, access to these conveyors could, for example, provide an agent at work station 124 with ready access to all the drive-thru bays in the facility.

In each case, owing to the open nature of the conveyors 108-122, each group of conveyors can be accessed by at least two agents. It can be seen, for example, that an agent working at work station 128 will have access to the same group of conveyors 112, and therefore the same set of destinations, as an agent working at work station 130.

Although prior conveyor terminal designs have provided a certain level of access between a single conveyor terminal and multiple transaction agents, no prior design has provided the efficiency gains made possible through the use of present invention. In any design wherein a single-sided conveyor terminal is accessible by more than one transaction agent, human ergonomics impose significant limitations to flexibility. These limitations are necessarily imposed by the fact that a single-sided conveyor terminal can only be accessed from a single side. Accordingly, while one such conveyor terminal can be realistically used by two transaction agents disposed adjacent to one another, two such single-sided conveyor terminals begin to present ergonomics issues whenever either of the two transaction agents has a need to access the terminal furthest from his workstation.

With the design as described, there will often be the situation wherein each of two transaction agents has simultaneous a need to reach the conveyor terminal furthest from his workstation. The transaction agents are then regularly reaching past one another's workspaces, or work envelopes, in order to perform their basic job functions. The sharing of work envelopes poses certain efficiency problems with as few as two such conveyors. These problems can become unworkable as more than two conveyors are so employed.

Through the use of dual-access or open-access conveyor terminals, the work envelopes of the individual tellers can be largely or completely segregated from one another, so that the interference inherent in the use of shared work envelopes can often be reduced or eliminated. Either agent on either side of a conveyor bank can readily handle transaction-related payloads arriving or departing through any of the conveyor terminals.

The ergonomic access described above is available without the necessity for any significant sharing of the workspace with the adjacent agent. Although those of skill in the art will recognize, that this direct and simultaneous ergonomic access to a large bank of conveyor terminals allows for a degree of flexibility and efficiency simply unavailable in prior designs. Although the scope of ergonomic access will vary from one workstation layout to another, for seated workstations, “ergonomically accessible” space, or “ergonomic space” can be defined as the accessible space available to the transaction agent without leaving the seated position. For standing workstations, “ergonomically accessible” space, or “ergonomic space” can be defined as the floor space principally or exclusively dedicated to that workstation and the space within reach of a person standing within that space.

In certain embodiments of the present invention, upsend tubular conveyors 108-114 and downsend tubular conveyors 116-122 are pneumatic tubular conveyors of the type known to those of skill in the art. In these conveyors, an air pressure differential is imposed between the front and the back of a cylindrical carrier using fans, air pumps, or similar devices. The imposed air pressure differential imparts a force on the pressurized end of the carrier, thereby accelerating the carrier in the direction of the lower pressure. The operation and design of such conveyors are well-known to those of skill in the art.

Although a pneumatic conveyor is well-suited to the present invention, nothing within the nature of the invention limits its use to pneumatic conveyors. As an example, a conveyor using an electromagnetic propulsion system could be employed without departing from the spirit and scope of the present invention.

In order to maximize the efficiency of the agents working at agent center 100, each pair of work stations shares one cash dispenser such as cash dispensers 132, 134 and 136. For example, work stations 124 and 126 share cash dispenser 132. Of course, cash dispensers 132-136 will only be employed in those applications, such as in financial institutions, in which the relevant transactions involve cash.

Agent center 100 enables the use of more efficient transaction handling methods and processes for distributing documents through a facility. The present invention allows for substantial efficiency improvements over prior systems. An example of the type of institution able to make use of teller center 100 is a banking facility, but there is nothing within the spirit and scope of the present invention limiting it to any particular market or area of endeavor. The teachings of the present invention are useful in any business or facility in which a significant volume of transactions must be handled with limited resources.

The distribution system of which teller center 100 is a central component is designed to maximize the efficiency of the agents working with documents and other small payloads. The distribution system of the present invention additionally provides for a significant improvement in the flexibility of such employees.

In contrast to the layout of teller center 100, certain prior customer interface facilities centralize agents along a single counter. This type of layout is common, for example, in bank lobbies and movie theater ticket counters. In banking facilities, these teller counters are also equipped with pneumatic conveyors in communication with the drive-thru bays. Generally, these pneumatic conveyors are disposed in relatively close proximity to the counters, so that tellers working at the counters can be relatively easily re-deployed to service at the drive-thru conveyors. Further, the teachings of the present invention are particularly suitable for use with tellerless bank lobbies employing interactive kiosks. The high level of efficiency and flexibility afforded by the present invention can work in synergy with these newer bank lobby styles to provide a much higher level of efficiency and flexibility than that traditionally available.

The traditional bank lobby arrangement allows for efficiency improvements over more traditional designs having a first set of dedicated tellers for the teller counters and a second set of dedicated tellers for the drive-thru bays, but is notably inferior to the system of the present invention. Although the traditional arrangement provides for a certain additional level of flexibility over an arrangement having a first set of dedicated drive-thru tellers and a second set of dedicated walk-up tellers, there are much greater efficiency gains to be realized.

A traditional pneumatic conveyor network, such as that used to convey documents to and from a drive-thru bay, is generally a single point-to-point apparatus. A certain inherent efficiency of the pneumatic conveyor increases the efficiency of the process as a whole, but the drive-thru conveyor does not take full advantage of the potential synergy between the conveyor apparatus and efficiency improvements available through the use of other labor-saving devices, such as cash dispensers 132-136.

The efficiency improvements are particularly apparent in those applications wherein the volume of transactions per unit time is highly variable. In a bank branch, for example, there may be significant periods of time during which there are no customers at the branch. Given this, it would be rational for the bank to minimize the number of tellers working in customer interface positions during those periods, in order to employ the tellers in other productive activities.

Even during periods of low transaction activity, however, there remains the probability that a customer will arrive and require attention. There is also a distinct possibility that two or more customers may require attention at the same time. It is on these occasions that the advantages of the present invention are most apparent. Properly arranged, the present invention can enable a single teller to have simultaneous access to a number of remote locations from a single work station. A teller working from work station 124, for example, has simultaneous access to the destinations served by upsend conveyors 108 and 110, as well as the destinations served by downsend conveyors 116 and 118.

It is possible for a single transaction agent, such as a bank teller, to manage two or more customers simultaneously owing to the fact that transactions generally require at least one conveyor transmittal from the customer to the teller, and at least one conveyor transmittal from the teller back to the customer. Many transactions require more than one of each, and many entail situations where a customer spends time filling out materials transmitted by the teller. In these situations, there is a often a significant amount of time during which the teller is otherwise idle, waiting for the completion of the transmission or for the customer to complete his tasks. The present invention allows that otherwise wasted time to be spent dealing with other customers in an optimal manner.

Of course, at some point, the teller's time is completely occupied. After the point at which the teller's time is completely occupied, addition of customer management tasks begins to increase customer wait time and attendant customer dissatisfaction. After such point, additional staffing is necessary to maintain customer wait time to an acceptable level.

Once two or more agents are staffing a set of customer interface points, the present invention can be employed to even the workload between the agents. For example, an agent at work station 128 has access to upsend conveyors 112 as well as downsend conveyors 120. An agent at work station 130 has access to the same set of conveyors 112 and 120. Depending on the current relative workloads of the agents, either agent can handle a customer request from a remote location connected to a conveyor 112 or 120. Accordingly, any new customer requests from these locations can be directed to whichever of the two agents currently has the lighter workload.

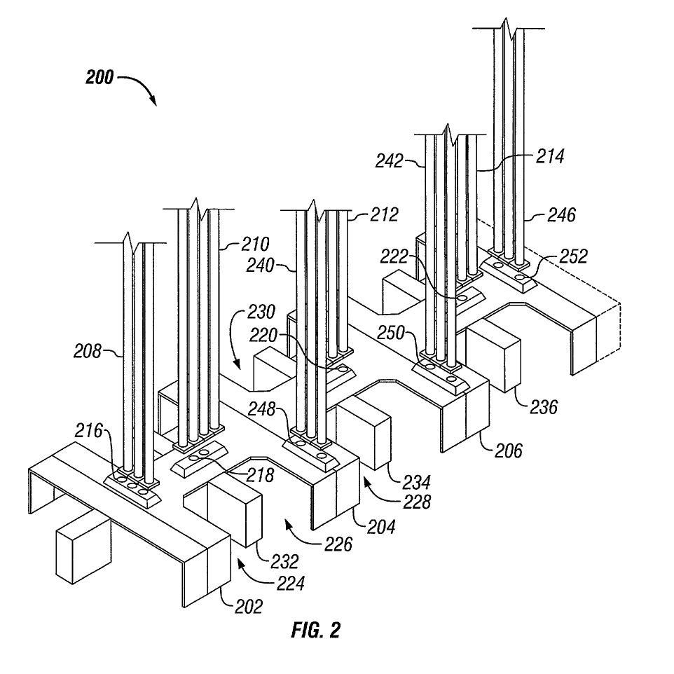

FIG. 2 is an isometric view of an agent center 200 of transaction agent stations in accordance with a second embodiment of the present invention. As seen in FIG. 1, agent center 200 of transaction agent stations is very similar to agent center 100 of FIG. 1. Agent center 200 incorporates a group of three cells 202, 204, and 206. In the embodiment shown in FIG. 2, each of cells 202-206 incorporates four transaction agent stations, so that agent center 200 can potentially accommodate up to twelve transaction agents at one time.

As with agent center 100, materials can be rapidly and efficiently moved to and from agent center 200 by means of a series of tubular conveyors arranged generally along the center of agent center 200 between the transaction agents. Upsend tubular conveyors 208 are arranged at one end of agent center 200, while upsend tubular conveyors 210, 212, and 214 are arranged down the center of the agent center 200. In the embodiment shown in FIG. 2, upsend tubular conveyors 208-214 employ an open arrangement allowing agents to access delivered contents from either side of the conveyors.

In addition to upsend conveyors 208-214, agent center 200 employs a set of downsend conveyors. Downsend tubular conveyors 216 are arranged at one end of agent center 200, while downsend tubular conveyors 218, 220, and 222 are arranged down the center of the agent center 200. In a similar manner to that described in connection with upsend conveyors 208-214, downsend tubular conveyors 216-222 employ an open arrangement allowing agents to access delivered contents from either side of the conveyors.

In addition to tubular conveyors 208-222, which correspond generally to tubular conveyors 108-122 shown in FIG. 1, agent center 200 incorporates three additional sets of upsend conveyors 240, 242, and 246, and three additional sets of downsend conveyors 248, 250, and 252. These conveyors 240-252 can be employed to provide yet another degree of flexibility over and above that provided by conveyors 208-222, as described below.

Each of the tubular conveyors 208-222 and 240-252 connects agent center 200 to one or more destinations remote from agent center 200. Downsend tubular conveyors 216, for example, may be connected to deliver materials to and from a set of drive-thru bays in a bank branch. At the same time, upsend conveyors 208 may be connected to deliver materials to and from agents working at customer service desks. The remainder of tubular conveyors 208-222 and 240-252 will be connected to other remote locations as requirements dictate. In certain embodiments, one or more of tubular conveyors 208-222 and 240-252 may be connected to another agent center.

In certain embodiments, each bank of tubular conveyors may be connected to a set of similar destinations. Connection of each of tubular conveyors 208 to a single bank drive-thru bay is such an example. In other embodiments, each bank of tubular conveyors may include one conveyor going each of a number of destinations. So, for example, the bank of conveyors numbered 210 may include one conveyor connected to a drive-thru bay, one conveyor connected to a customer service desk, one conveyor connected to a lobby teller machine, and one conveyor connected to another agent center. Other variations will be apparent to those of skill in the art.

As with agent center 100, agents work in conjunction with the agent center 200 from within work stations such as 224, 226, 228, and 230. From each work station, an agent has access to a certain subset of the tubular conveyors 208-222 and 240-252. For example, an agent working from work station 224 will have ready access to conveyors 208, 210, 216, and 218. Depending on the manner of connection scheme employed, access to these conveyors could, for example, provide an agent at work station 224 with ready access to all the drive-thru bays in the facility.

In each case, owing to the open nature of the conveyors 208-222 and 240-252, each group of conveyors can be accessed from at least two work stations. It can be seen, for example, that both an agent working at work station 228 and an agent working at work station 230 will have access to conveyors 212. Owing to the addition of conveyors 240, 242, 248, and 250, agents at the various work stations do not share identical sets of conveyors, as was the case in agent center 100. For example an agent at work station 228 has shared access to certain conveyors with an agent at work station 230, and shared access to certain other conveyors with an agent at work station 226. With this arrangement, an agent at work station 228 may be employed to assist with the workload handled by the agent at work station 226, the agent at work station 230, or both, as requirements dictate.

In order to maximize the efficiency of the agents working at agent center 200, each pair of work stations shares one cash dispenser such as cash dispensers 232, 234 and 236. For example, work stations 224 and 226 share cash dispenser 232. Of course, cash dispensers 232-236 will only be employed in those applications, such as in financial institutions, in which the relevant transactions involve cash.

As described in connection with FIG. 1, a range of variations and embodiments of teller center 200 will be apparent to those of skill in the art. In addition to the possible variations described in connection with teller center 100, all of which apply here, teller center 200 provides an additional range of variations related to the placement of conveyors 240, 242, 248, and 250. For example, a corresponding set of conveyors is not shown opposite these conveyors, but a set of such conveyors would provide additional advantages and are within the scope of the present invention. As another example, these side conveyors could be all upsend, all downsend, or any combination thereof.

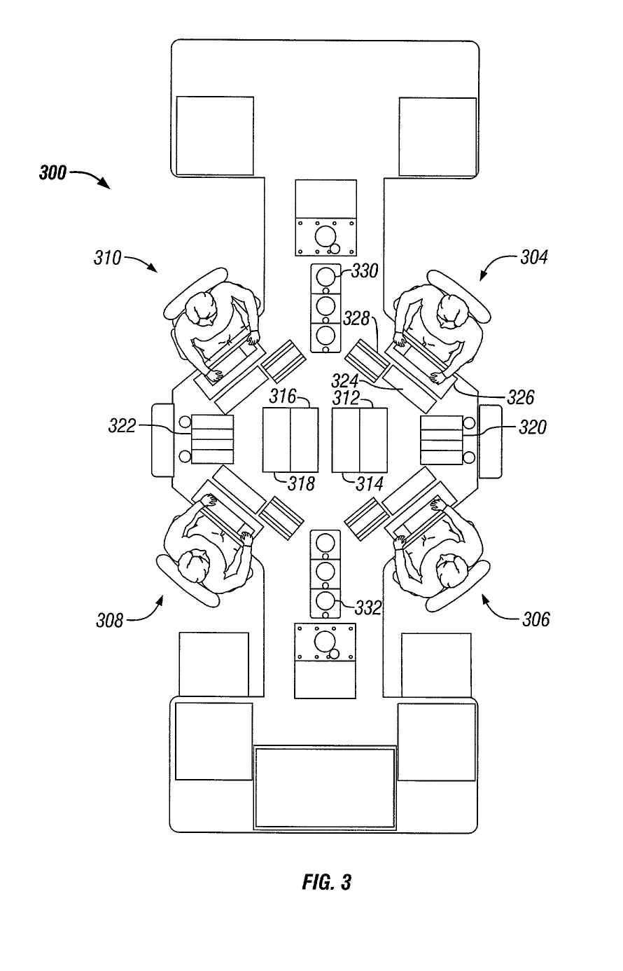

FIG. 3 is a top view of a four-place transaction agent cell 300 in accordance with one embodiment of the present invention. It will be noted that agent cell 300 differs slightly in layout from the agent cells 102-106 and 202-206 described above. Both layouts, as well as similar layouts having the same general manner of operation, are within the spirit and scope of the present invention.

Agent cell 300 includes four agent work stations 304, 306, 308, and 310. Each of work stations 304-310 is connected to one of local CPUs 312, 314, 316 or 318. Local CPUs 312-318 may be connected to a network linking them to one or more servers, thereby allowing local CPUs 312-318 to access one or more databases useful in performing necessary transactions.

Each of agent work stations 304-310 incorporates a set of peripherals for use by the agent using the work station. Work station 304, for example, incorporates a display screen 324, a keyboard 326, and an audio-visual intercom 328. Work stations 306-310 are equipped in a similar manner. Display screen 324 and keyboard 326 are connected to the local CPU assigned to work station 304 and are useful for accessing software used by the agents in performing transactions.

In addition to the resources and peripherals dedicated to each of the work stations 304-310, agent center 300 incorporates a number of shared resources. These shared resources include coin dispensers 320 and 322 and tubular conveyors 330 and 332. Coin dispenser 320 is shared by work stations 304 and 306, while coin dispenser 322 is shared by work stations 308 and 310.

Tubular conveyors 330 are shared between work stations 304 and 310, while tubular conveyors 332 are shared between work stations 306 and 308. Tubular conveyors 330 may be upsend conveyors, downsend conveyors, or a combination of both. Similarly, tubular conveyors 332 may be upsend conveyors, downsend conveyors, or a combination of both. Further, although FIG. 3 depicts four of conveyors 330 and four of conveyors 332, nothing within the spirit and scope of the present invention limits either set of conveyors to that number, or requires that both sets of conveyors have the same number.

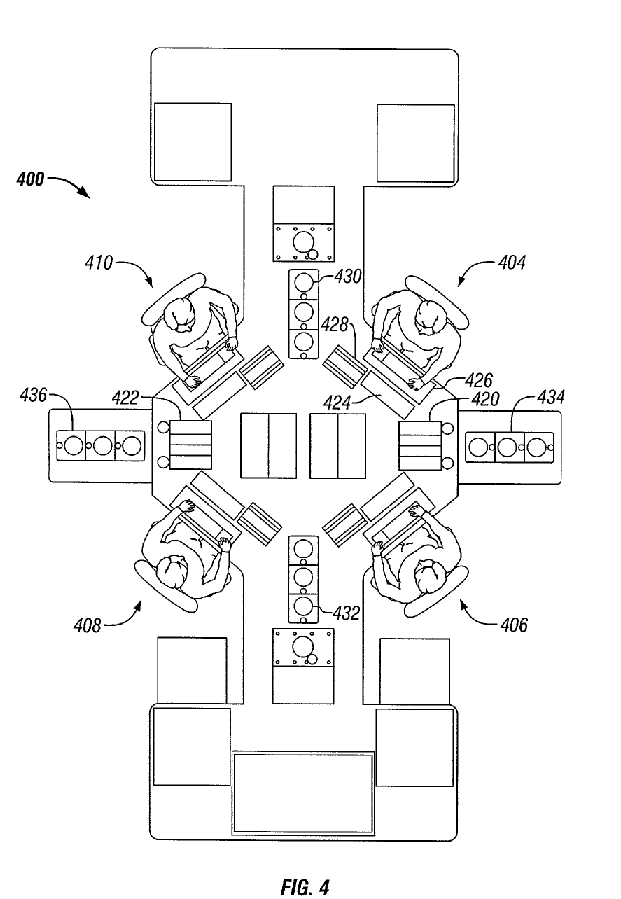

FIG. 4 is a top view of a four-place transaction agent cell 400 in accordance with one embodiment of the present invention. It will be noted that agent cell 400 differs slightly in layout from the agent cells 102-106 and 202-206 described above, as well as from agent cell 300. Each of these layouts, as well as similar layouts having the same general manner of operation, are within the spirit and scope of the present invention.

Agent cell 400 includes four agent work stations 404, 406, 408, and 410. Each of work stations 404-410 is connected to one of local CPUs 412, 414, 416 or 418. Generally, local CPUs 412-418 will be connected to a network linking them to one or more servers, thereby allowing local CPUs 412-418 to access one or more databases useful in performing necessary transactions.

Each of agent work stations 404-410 incorporates a set of peripherals for use by the agent using the work station. Work station 404, for example, incorporates a display screen 424, a keyboard 426, and an audio-visual intercom 428. Work stations 406-410 are equipped in a similar manner. Display screen 424 and keyboard 426 are connected to the local CPU assigned to work station 404 and are useful for accessing software used by the agents in performing transactions.

In addition to the resources and peripherals dedicated to each of the work stations 404-410, agent center 400 incorporates a number of shared resources. These shared resources include coin dispensers 420 and 422 and tubular conveyors 430, 432, 434, and 436. Coin dispenser 420 is shared by work stations 404 and 406, while coin dispenser 422 is shared by work stations 408 and 410.

The sharing of the tubular conveyors 430-436 will be seen to differ from that of agent cell 300 in the same manner that the sharing of tubular conveyors in agent center 200 differs from that of agent center 100. In a vary similar manner to that shown in FIG. 3, tubular conveyors 430 are shared between work stations 404 and 410, while tubular conveyors 432 are shared between work stations 406 and 408.

Contrasting with the arrangement of agent cell 300, agent cell 400 incorporates tubular conveyors 434 and 436, which do not correspond to any of the conveyors in agent cell 300. Tubular conveyors 434 are shared between work stations 404 and 406, while tubular conveyors 436 are shared between work stations 408 and 410. The potential advantages of these additional conveyors are described above in connection with FIG. 2.

Tubular conveyors 330-336 may be upsend conveyors, downsend conveyors, or a combination of both. Further, although FIG. 4 depicts four conveyors in each of the sets of conveyors 330-336, nothing within the spirit and scope of the present invention limits either set of conveyors to that number, or requires that both sets of conveyors have the same number.

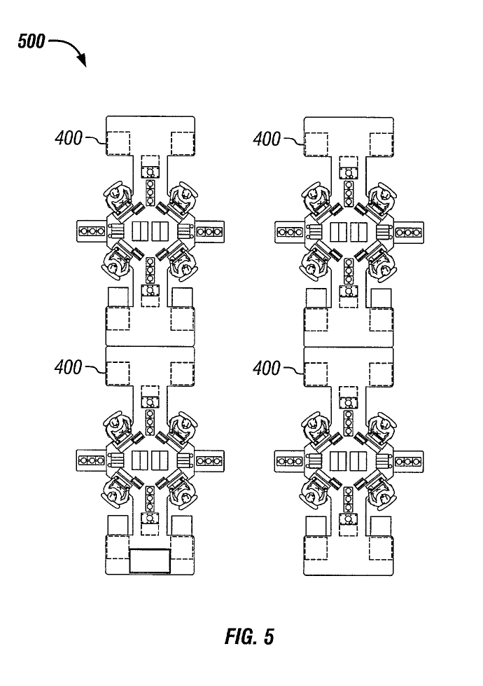

FIG. 5 is a top view of an array 500 of four-place transaction agent cells 400 in accordance with one embodiment of the present invention. Such a layout facilitates the collection of up to sixteen agents in a single location, any one of which will have access to remote locations via one or more conveyors in close proximity. It will be recognized by those of skill in the art that the two-by-two arrangement of transaction agent cells 400 shown in FIG. 5 is but one of many potential layouts. Further, although array 500 is composed of four agent cells 400, it will be appreciated that any of the cells described above, or a combination of the same, is within the spirit and scope of the present invention.

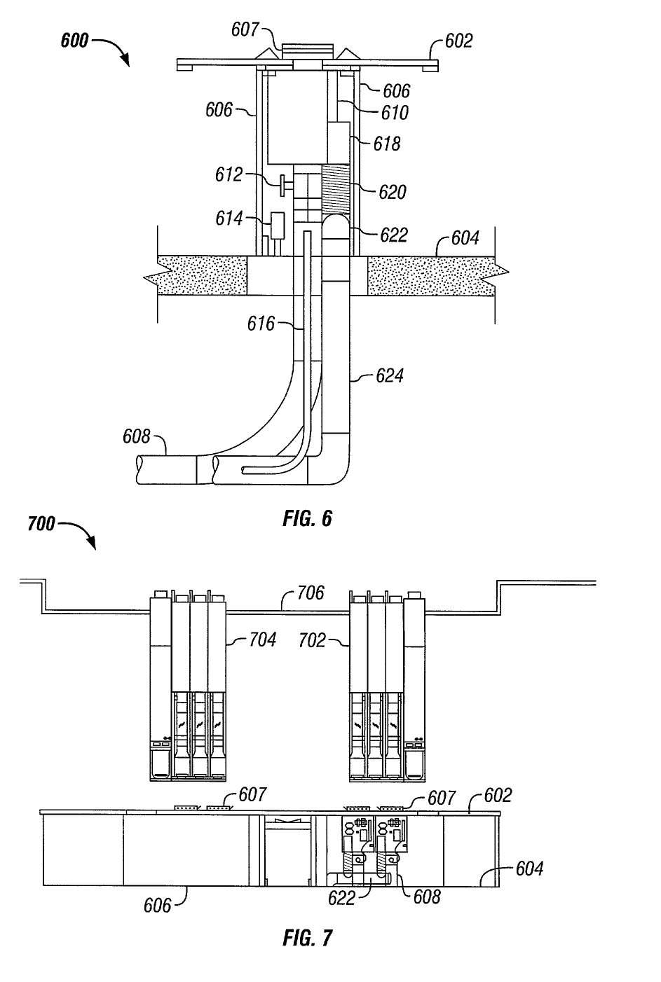

FIG. 6 is a side view of the base portion of a transaction agent cell 600 in accordance with one embodiment of the present invention, while FIG. 7 is a front view of a four-place transaction agent cell in accordance with one embodiment of the present invention.

It can be seen in FIGS. 6 and 7 that transaction agent cell 600 is built into a countertop 602 disposed some height above the floor 604 of the facility. The portions of agent cell 600 to which access is not required during normal operation are normally concealed by one or more access panels 606. A downsend conveyor lift station 607 is built into the countertop 602. Lift station 607 sends and receives materials to and from remote locations through conveyor tube 608 under the control of lift station controls 610. The presence or absence of a transmission or payload is detected by photocell assembly 612, and the lift station 607 receives electrical power through power connection 614.

Control and communication signals are routed to and from agent cell 600 through conduit 616. These signals may include audio and visual communications between the remote customer and the agent. These signals may also include routing information in those situations where a single conveyor tube is connected to multiple destinations.

Carriers arriving at the lift station 607 will have high pressure air pushing them up through the tube. In order to avoid the creation of a blast of air as the carrier exits the top of the lift station 607, the pressurized air behind the carrier is routed through an exhaust port 618 through a flexible coupling 620, to an exhaust manifold 622 connected to an exhaust pipe 624.

The general construction of certain upsend conveyors 702 and 704 useful in connection with the present invention are also shown in FIG. 7. Conveyors 702 and 704 transport payloads from the agent cell 600, up through the ceiling 706 to remote locations (not shown). As described above, the remote locations served by upsend conveyors 702 and 704 will vary depending on the application. In one embodiment of the present invention, the center six conveyors are connected to lobby teller machines, while the outer two conveyors are connected to customer service desks.

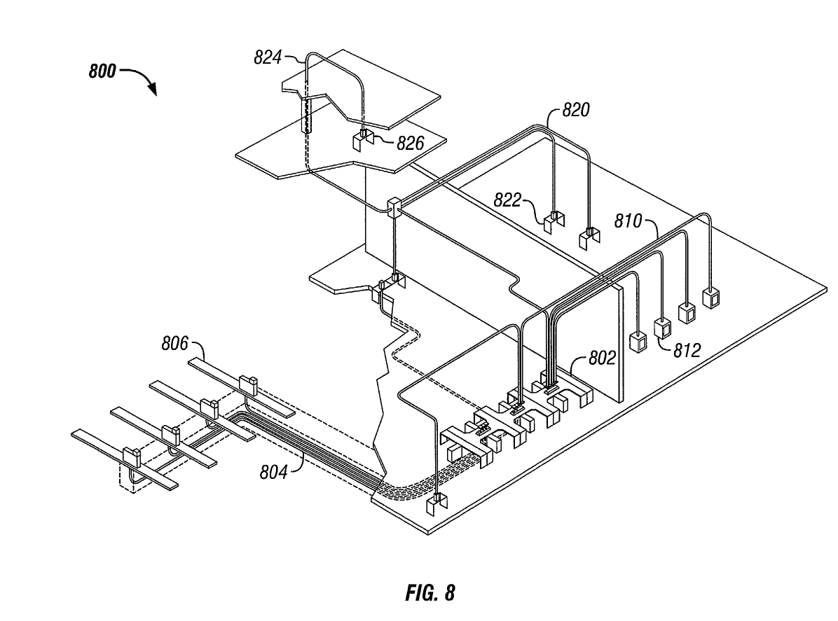

FIG. 8 is an isometric view of a conveyor system 800 in accordance with one embodiment of the present invention. Conveyor system 800 is built into a bank branch. As seen in FIG. 8, conveyor system 800 incorporates a central teller station 802 physically connected to a set of remote locations via a network of conveyors.

Central teller station 802 may be modeled on any of the agent centers shown in FIGS. 1-7 and described in connection therewith. Depending on the demands of the application, central teller station 802 may incorporate one teller work station, or may incorporate a large number of teller work stations In installations wherein the customer transaction workload varies widely during the day or from day-to-day, the teller center may be fully staffed during certain periods and lightly staffed during others.

As noted, central teller station 802 is connected to remote locations via an array of conveyors. The conveyors employed may be of any suitable type known to those of skill in the art. Pneumatic tube conveyors are one type of conveyor known to be useful for this purpose. As seen in FIG. 8, drive-thru conveyors 804 connect central teller station 802 to drive-thru bays 806. With this arrangement, customer transactions originating from drive-up customers in the drive-thru bays 806 can be handled in a quick and efficient manner with a minimum of waste. Depending on the requirements of a particular application, drive-thru conveyors 804 may be directed to a single teller work station within the central teller station 802, or may be distributed to a number of teller work stations. In addition to the physical connection provided by drive-thru conveyors 804, teller work stations within central teller station 802 are connected to drive thru bays 806 by one or more electronic connections allowing for audio communication between the customer and the teller. Such electronic connections may also include provisions for video connection as well.

In a similar manner, lobby teller conveyors 810 connect central teller station 802 to lobby teller machines 812. Lobby teller machines 812 operate in a similar manner to automatic teller machines (ATMs), except that each of the lobby teller machines 812 is manned by a teller in central teller station 802. As such, the lobby teller machines 812 provide additional functionality and a personal touch. With this arrangement, customer transactions originating from walk-up customers in the lobby can be handled in a quick and efficient manner. Depending on the application, lobby teller conveyors 810 may be directed to a single teller work station within the central teller station 802, or may be distributed to a number of teller work stations. In addition to the physical connection provided by lobby teller conveyors 810, teller work stations within central teller station 802 are connected to the lobby teller machines 812 by one or more electronic connections allowing for audio communication between the customer and the teller. Such electronic connections may also include provisions for video connection as well.

In addition to the drive-thru conveyors 802 and the lobby teller conveyors 810, conveyor system 800 provides connections to a number of other remote locations in order to improve efficiency. Examples of other such connections include customer service conveyors 820 to customer service desks 822 and internal operations conveyor 824 to internal audit desk 826. Each of these conveyors has a similar functionality and provides similar advantages, with the exception that these conveyors are designed for communication between employees of the facility rather that between tellers and customers. Accordingly, these connections may be designed without certain features, such as video communication capability, as an example. Otherwise, the operation of these conveyors will generally be identical to the other conveyors in the facility.

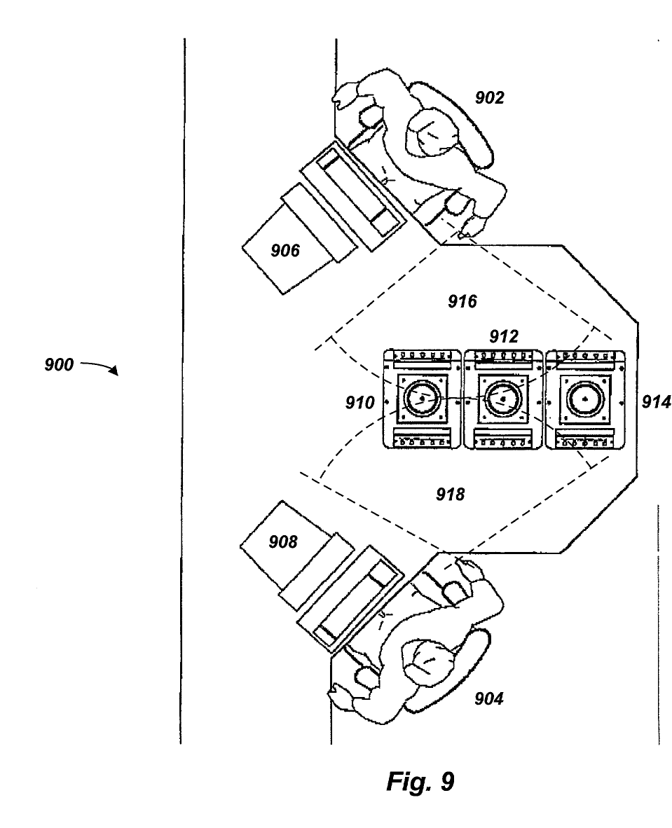

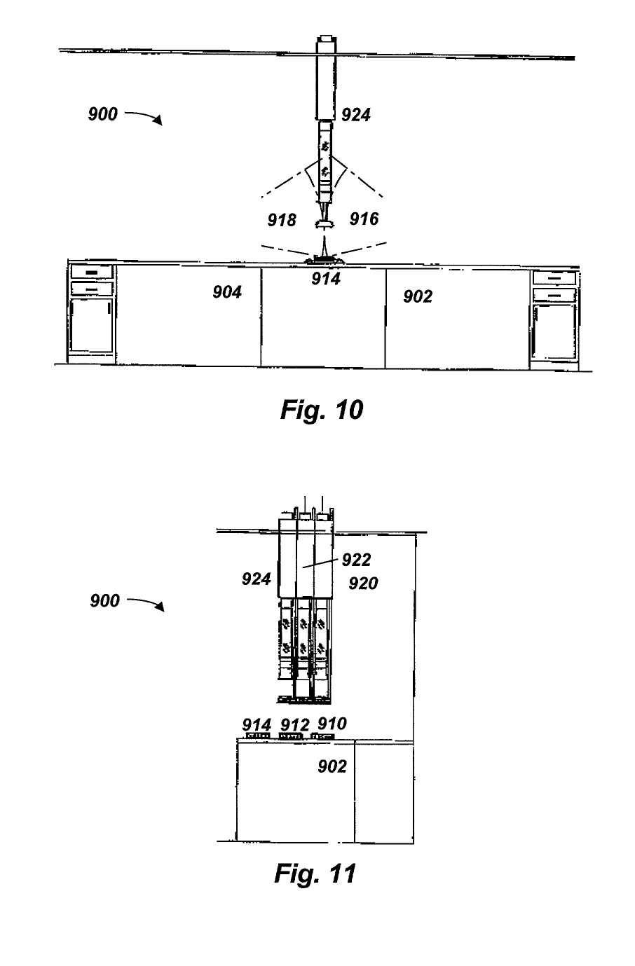

FIG. 9 is a plan view of a two-place transaction agent cell in accordance with one embodiment of the present invention. FIG. 10 is a front elevation view of the two-place transaction agent cell of FIG. 9. FIG. 11 is a side elevation view of the two-place transaction agent cell of FIG. 9.

Two-place transaction agent cell 900 includes a first agent workstation 902 and a second agent workstation 904. Depending on the application, agent workstations 902 and 904 may be disposed so that agents face a wall in an enclosed space, or they may be disposed so that agents may interact with customers across the countertop of transaction agent cell 900, as in a lobby. In the embodiment shown in FIG. 9, agent workstations 902 and 904 include computer terminals 906 and 908, respectively.

Disposed between agent workstation 902 and agent workstation 904 is a set of six conveyor terminals, which includes three downsend conveyor terminals 910-914 and three upsend conveyor terminals 920-924. Depending on the application, some or all of conveyor terminals 910-914 and 920-924 may be dual-access dual-control terminals, so that a transaction agent at workstation 902 has full ergonomic access to, and control of, each of conveyor terminals 910-914 and 920-924. With such an arrangement, a transaction agent at workstation 904 has an equal degree of ergonomic access to, and control of, the same conveyor terminals.

Although prior conveyor terminal designs have provided a certain level of access between a single conveyor terminal and multiple transaction agents, no prior design has provided the efficiency gains made possible through the use of present invention. In any design wherein a single-sided conveyor terminal is accessible by more than one transaction agent, human ergonomics impose significant limitations to flexibility. These limitations are necessarily imposed by the fact that a single-sided conveyor terminal can only be accessed from a single side. Accordingly, while one such conveyor terminal can be realistically used by two transaction agents disposed adjacent to one another, two such single-sided conveyor terminals begin to present ergonomics issues whenever either of the two transaction agents has a need to access the terminal furthest from his workstation.

With the design as described, there will often be the situation wherein each of two transaction agents has simultaneous a need to reach the conveyor terminal furthest from his workstation. The transaction agents are then regularly reaching past one another's workspaces, or work envelopes, in order to perform their basic job functions. The sharing of work envelopes poses certain efficiency problems with as few as two such conveyors. These problems can become unworkable as more than two conveyors are so employed.

Through the use of dual-access or open-access conveyor terminals, the work envelopes of the individual tellers can be largely or completely segregated from one another, so that the interference inherent in the use of shared work envelopes can often be reduced or eliminated. In FIGS. 9 and 10, the seated work envelopes for workstations 902 and 904 are designated 916 and 918, respectively. As can be seen through reference to these figures, a transaction agent at workstation 902 has direct and ready ergonomic access to each of conveyor terminals 910-914 and 920-924. At the same time, a transaction agent at workstation 904 has direct and ready ergonomic access to the same conveyor terminals 910-914 and 920-924. Either agent can readily handle transaction-related payloads arriving or departing through any of the conveyor terminals.

The ergonomic access described above is available without the necessity for any significant sharing of the workspace with the adjacent agent. Although those of skill in the art will recognize, that this direct and simultaneous ergonomic access to a large bank of conveyor terminals allows for a degree of flexibility and efficiency simply unavailable in prior designs. Although the scope of ergonomic access will vary from one workstation layout to another, for seated workstations, “ergonomically accessible” space can be defined as the accessible space available to the transaction agent without leaving the seated position. For standing workstations, “ergonomically accessible” space can be defined as the floor space principally or exclusively dedicated to that workstation and the space within reach of a person standing within that space.

Although preferred embodiments of the invention have been described in detail, it will be understood by those skilled in the art that various modifications can be made therein without departing from the spirit and scope of the invention as set forth in the appended claims.

What is claimed is:

1. A system for conducting transactions comprising:
a first agent work station having an ergonomic space;
a second agent work station having an ergonomic space;
a first conveyor terminal at least partly disposed within the ergonomic space of both the first and second agent work stations, operably connected to a first conveyor for delivery to a first destination; and
a second conveyor terminal at least partly disposed within the ergonomic space of both the first and second agent work stations, operably connected to a second pneumatic conveyor for delivery to a second destination.

2. The system of claim 1 wherein the first destination is a drive-thru bay.

3. The system of claim 1 wherein the first destination is a customer service desk.

4. The system of claim 1 wherein the first destination is a lobby terminal.

5. The system of claim 1 wherein the second destination is a drive-thru bay.

6. The system of claim 1 wherein the second destination is a customer service desk.

7. The system of claim 1 wherein the second destination is a lobby terminal.

8. The system of claim 1 wherein the first and second teller work stations are disposed within a secure facility.

9. The system of claim 1 wherein the first conveyor terminal is upward-acting.

10. The system of claim 9 wherein the second conveyor terminal is upward-acting.

11. The system of claim 9 wherein the second conveyor terminal is downward-acting.

12. A system for conducting transactions comprising:
a first agent work station having an ergonomic space;
a second agent work station having an ergonomic space;
a third agent work station having an ergonomic space;
a first conveyor terminal at least partly disposed within the ergonomic space of both the first and second agent work stations, operably connected to a first conveyor for delivery to a first destination; and
a second conveyor terminal at least partly disposed within the ergonomic space of both the second and third agent work stations, operably connected to a second pneumatic conveyor for delivery to a second destination.

13. The system of claim 12 wherein the first destination is a drive-thru bay.

14. The system of claim 12 wherein the first destination is a customer service desk.

15. The system of claim 12 wherein the first destination is a lobby terminal.

16. The system of claim 12 wherein the second destination is a drive-thru bay.

17. The system of claim 12 wherein the second destination is a customer service desk.

18. The system of claim 12 wherein the second destination is a lobby terminal.

19. The system of claim 12 wherein the first and second teller work stations are disposed within a secure facility.

20. The system of claim 12 wherein the first conveyor terminal is upward-acting.

21. The system of claim 20 wherein the second conveyor terminal is upward-acting.

22. The system of claim 20 wherein the second conveyor terminal is downward-acting.

23. The system of claim 12 wherein the first agent work station and the first destination are connected by an audio-visual intercom.

24. A system for conducting transactions comprising:
a first agent work station having an ergonomic space;
a second agent work station having an ergonomic space;
a third agent work station having an ergonomic space;
a fourth agent work station having an ergonomic space;
a first conveyor terminal having a first upward-acting conveyor operably connected to a first destination and a first downward-acting conveyor operably connected to a second destination, disposed at least partly within the ergonomic space of both the first and second agent work stations;
a second conveyor terminal having an upward-acting conveyor operably connected to a third destination and a downward-acting conveyor operably connected to a fourth destination, disposed at least partly within the ergonomic space of both the second and third agent work stations; and
a third conveyor terminal having an upward-acting conveyor operably connected to a fifth destination and a downward-acting conveyor operably connected to a sixth destination, at least partly disposed within the ergonomic space of both the third and fourth agent work stations.

25. The system of claim 24 wherein the first destination is a drive-thru bay.

26. The system of claim 24 wherein the first destination is a customer service desk.

27. The system of claim 24 wherein the first destination is a lobby terminal.

28. The system of claim 24 wherein the second destination is a drive-thru bay.

29. The system of claim 24 wherein the second destination is a customer service desk.

30. The system of claim 24 wherein the second destination is a lobby terminal.

31. The system of claim 24 wherein the first and second teller work stations are disposed within a secure facility.

32. The system of claim 24 wherein the first agent work station and the first destination are connected by an audio-visual intercom.

33. The system of claim 24 wherein the first agent work station and the second destination are connected by an audio-visual intercom.

34. The system of claim 24 wherein the second agent work station is connected to the first, second, third, and fourth destination by an audio-visual intercom.

35. The system of claim 12 wherein the first agent work station and the first destination are connected by an audio-visual intercom.

36. A teller center for conducting financial transactions in a bank comprising:
a first teller work station having an ergonomic space;
a second teller work station having an ergonomic space;
an upward-acting conveyor terminal at least partly disposed within the ergonomic space of both the first and second teller work stations, operably connected to a first conveyor for delivery to a first destination; and
a downward-acting conveyor terminal at least partly disposed within the ergonomic space of both the first and second teller work stations, operably connected to a second pneumatic conveyor for delivery to a second destination.

37. The teller center of claim 36 wherein the first destination is a drive-thru bay.

38. The teller center of claim 36 wherein the first destination is a customer service desk.

39. The teller center of claim 36 wherein the first destination is a lobby terminal.

40. The teller center of claim 36 wherein the second destination is a drive-thru bay.

41. The teller center of claim 36 wherein the second destination is a customer service desk.

42. The teller center of claim 36 wherein the second destination is a lobby terminal.

43. The teller center of claim 36 wherein the first and second teller work stations are disposed within a secure facility.
